(19) United States
(12) Patent Application Publication
(10) Pub. No.: US 2013/0192909 A1
(43) Pub. Date: Aug. 1, 2013

(54) POWER SUPPLY APPARATUS OF ELECTRIC CAR AND METHOD OF CONTROLLING THE SAME

(71) Applicant: Kyung Soo KIM, Buyeo-gun (KR)

(72) Inventor: Kyung Soo KIM, Buyeo-gun (KR)

(21) Appl. No.: 13/709,176

(22) Filed: Dec. 10, 2012

(30) Foreign Application Priority Data
Feb. 1, 2012 (KR) 10-2012-0010344

(51) Int. Cl. B60L 11/18

(52) U.S. Cl. CPC B60L 11/18
USPC 180/65.31

(57) ABSTRACT

A power supply apparatus of an electric car and a method of controlling the same. The power supply apparatus includes a small power generation unit including a plurality of small generators mounted on an axle shaft of wheels of the electric car, to which a main drive motor is not provided, and each generating allocated resupply power preset in association with rotation of the axle shaft; a charging unit including a battery mounted in a trunk of the electric car, the charging unit charging the battery with the power generated by the small power generation unit and supplying power for operation of electric and electronic circuits of the electric car and power for the main drive motor; and a controller having a function of treating an abnormal state of the small generators and controlling overall operation of the power supply apparatus.

### CROSS-REFERENCE TO RELATED APPLICATION

This application claims the benefit under 35 U.S.A. §119 of Korean Patent Application No. 10-2012-0010344, filed on Feb. 1, 2012 in the Korean Intellectual Property Office, the entirety of which is incorporated herein by reference.

### BACKGROUND

1. Technical Field

The present invention relates to a power supply apparatus of an electric car and a method of controlling the same. More particularly, the present invention relates to a power supply apparatus of an electric car, in which a plurality of small generators is mounted on an axle shaft of the electric car such that power generated by the small generators is supplied to a main generator to generate desired power for charging a battery of the electric car, thereby eliminating a need for a separate power source for actuation of the electric car, and a method of controlling the same.

2. Description of the Related Art

Generally, as energy and environmental problems have become a focus of attention due to depletion of fossil fuels, green cars, that is, eco-friendly vehicles having higher fuel efficiency and lower emission than existing internal combustion engine vehicles, have drawn attention.

Such green cars include hybrid cars, plug-in hybrid cars, clean diesel engine cars, fuel cell cars, electric cars, and the like. Recently, the Korean government pronounced a plan for mass production of electric cars in 2011, and it is expected that the demand for electric cars will rapidly increase.

Herein, the term “electric car” refers to all kinds of cars requiring electric charging. These types of electric cars are capable of being charged not only in a special charging station but also in a business or domestic station. Here, full charging of an electric car generally requires at least 4 hours, and rapid charging of the electric car requires at least 30 minutes. In addition, considering a typical life pattern, it can be anticipated that charging an electric car will be mainly performed before going to work or after leaving work.

FIG. 1 is a diagram of one example of an electric car in the art.

Referring to FIG. 1, an electric car 70 includes an electric motor 73 and a battery 75 for actuation of the electric car.

The electric motor 73 is provided to an axle shaft 72 of front wheels 71A of the electric car 70 and rotates the wheels 71A, 71B through the axle shaft 72. The battery 75 supplies power to the electric motor 73 and is received in a trunk of the electric car 70.

In operation of the electric car 70, with the battery 75 charged by a charging device 76, power is applied from the battery 75 to the electric motor 73 mounted on the axle shaft 72 of the front wheels 71A of the electric car 70 through a starter (not shown). Then, the electric motor 73 connected to the axle shaft 72 is actuated and rotates the front wheels of the electric car 70 connected to the axle shaft 72.

In this way, rotation of the front wheels 71A of the electric car 70 causes rotation of rear wheels 71B of the electric car 70, so that the electric car 70 is driven.

In a power supply apparatus of such a conventional electric car, the electric motor mounted on the axle shaft of the electric car is activated by power supplied from the charged battery. The battery of the electric car is charged in typical domestic or electric charging stations. However, charging the battery of the electric car is very difficult due to a preset power peak capacity and production of such charging power requires construction of many separate power plants, thereby causing environmental contamination.

Furthermore, the power supply apparatus of such a conventional electric car has a problem in that, even in the case where the electric car is provided with a main generator for charging the battery, the fuel efficiency of the electric car can be significantly reduced if the electric car is not periodically recharged.

One example of a method of generating power is disclosed in Korean Patent Publication No. 10-2011-0057788A.

### BRIEF SUMMARY

Therefore, the present invention is aimed at providing a power supply apparatus of an electric car, which can eliminate a separate power source for supplying power for actuation of an electric car, and a method of controlling the same.

In accordance with one aspect, the present invention provides a power supply apparatus of an electric car, which includes: a small power generation unit including a plurality of small generators mounted on an axle shaft of wheels of the electric car, to which a main drive motor is not provided, and each generating allocated resupply power preset in association with rotation of the axle shaft; a charging unit including a battery mounted in a trunk of the electric car, the charging unit charging the battery with the power generated by the small power generation unit and supplying power for operation of electric and electronic circuits of the electric car and power for the main drive motor; and a controller having a function of treating an abnormal state of the small generators and controlling overall operation of the power supply apparatus.

In accordance with another aspect, the present invention provides a method of controlling a power supply apparatus of an electric car, which includes: collecting allocated resupply AC power individually generated by small generators mounted on an axle shaft of the electric car to output resupply AC power, the allocated resupply AC power to be generated by each of the small generators being set by dividing total resupply power for the electric car by the number of small generators; converting the resupply AC power generated by the small generators into DC power; and generating charging power for a battery of the electric car using the resupply AC power generated by the small generators as actuation power.

According to the present invention, a plurality of small generators is mounted on the axle shaft of the electric car such that power generated by the small generators is resupplied to a main generator to generate desired power of high efficiency to charge a battery of the electric car, whereby the electric car can eliminate a need for a separate power source for actuation of the electric car, thereby maximizing fuel efficiency.

In addition, each of rotary gears provided to the plurality of small generators has a much smaller diameter than the diameter of a rotary gear mounted on the axle shaft and thus can be rotated at high speed. Accordingly, the small generators have improved power generation capability, thereby improving efficiency in production of electric energy.

### BRIEF DESCRIPTION OF THE DRAWINGS

The above and other aspects, features, and advantages of the invention will become apparent from the detailed description of the following embodiments in conjunction with the accompanying drawings, in which:

FIG. 1 is a diagram of one example of an electric car in the art;

FIG. 2 is a diagram of a power supply apparatus of an electric car in accordance with one exemplary embodiment of the present invention, in which four small generators are mounted on an axle shaft;

FIG. 3 is a diagram of a power supply apparatus of an electric car in accordance with another exemplary embodiment of the present invention, in which two small generators are mounted on an axle shaft;

FIG. 4 is a diagram of a power supply apparatus of an electric car in accordance with a further exemplary embodiment of the present invention, which further includes a main generator;

FIG. 5 is a diagram of secondary a power supply apparatus in the power supply apparatus of the electric car in accordance with the present invention;

FIG. 6 is a diagram of a main generator of the power supply apparatus of the electric car in accordance with the present invention; and

FIG. 7 is a flowchart of a method of controlling a power supply apparatus of an electric car in accordance with one exemplary embodiment of the present invention.

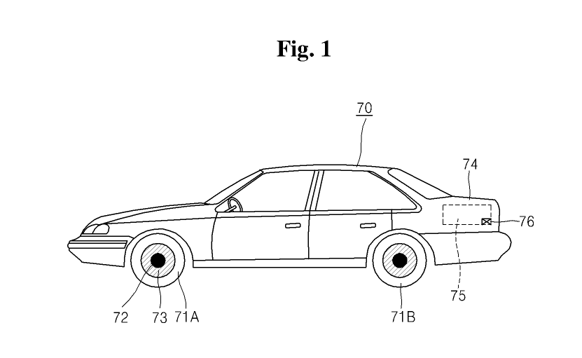

### DETAILED DESCRIPTION

Exemplary embodiments of the invention will now be described in detail with reference to the accompanying drawings.

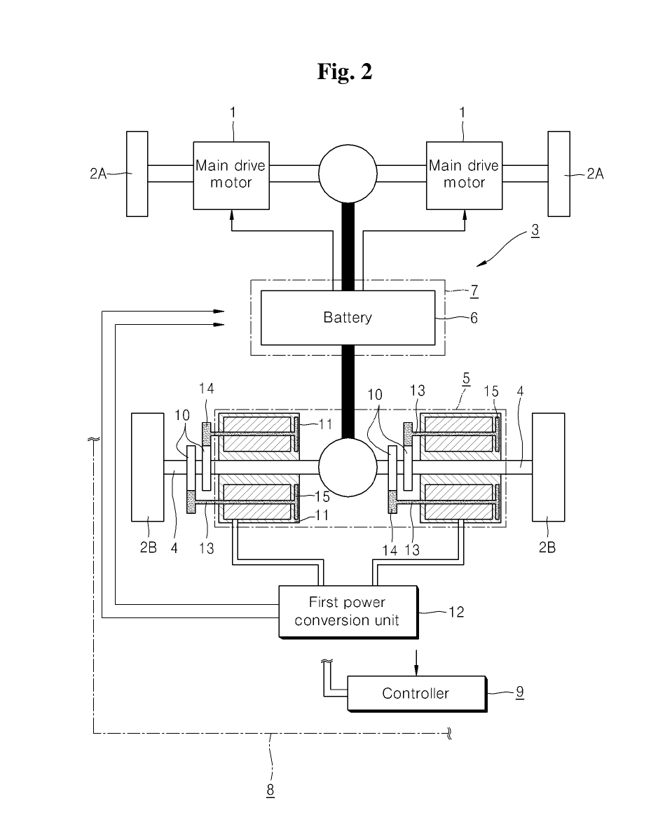

Referring to FIG. 2, the power supply apparatus of the electric car according to the present invention includes:

a small power generation unit 5 that is mounted on an axle shaft 4 of wheels 2B of an electric car 3, to which main drive motors 1 are not provided, and includes a plurality of small generators each generating allocated resupply power preset in association with rotation of the axle shaft 4;

a charging unit 7 that includes a battery 6 mounted in a trunk (not shown) of the electric car 3, charges the battery 6 with the power generated by the small power generation unit 5 and supplies power for operation of electric and electronic circuits of the electric car 3 and power for driving the main drive motors 1; and

a controller 9 that has a function of treating an abnormal state of the small power generation unit 5 and controls overall operation of the power supply apparatus 8 of the electric car 3.

The axle shaft 4 is provided with a plurality of concentric circle-shaped rotary gear members 10 rotated in association with rotation of the axle shaft 4.

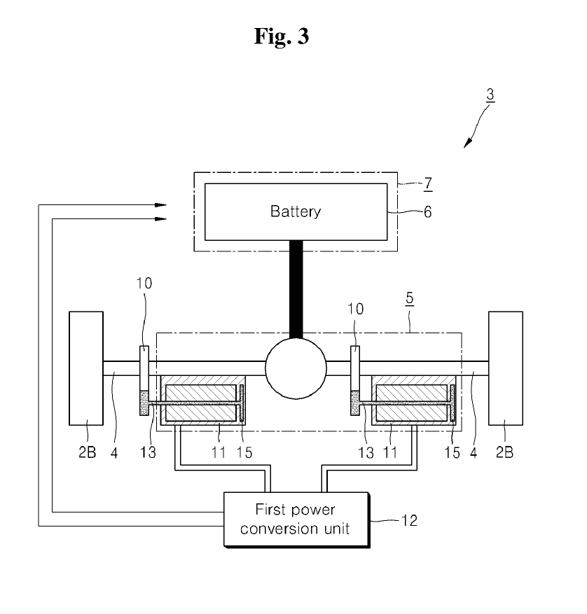

Referring to FIG. 3, in one embodiment of the present invention, the small generator unit 5 includes a pair of small generators 11 each provided to either side of the axle shaft 4 of the wheels 2B of the electric car 3 on which the main drive motors 1 are not mounted. In this embodiment, a first power conversion unit 12 is disposed between each of the small generators 11 and the charging unit 7 and converts AC power generated by the small generators 11 into DC power to supply the converted DC power to the charging unit 7 while checking a state of the power generated by the small generators 11 to output a checking result to the controller 9.

Referring to FIG. 2, in another embodiment of the present invention, the small generator unit 5 includes two pairs of main drive motors 1 each pair provided to either side of the axle shaft 4 of the wheels 2B of the electric car 3 on which the main drive motors 1 are not mounted.

In these embodiments, each of the small generators 11 includes a rotor shaft 13, which protrudes a predetermined length from a body of the small generator, and a high speed rotary gear member 14 formed in a small size on the rotor shaft 13 to have a predetermined gear ratio, for example, a gear ratio of 1/2 or 1/3 or less, with respect to the diameter of the rotary gear member 10 configured to rotate in connection with the axle shaft 4.

Here, the configuration of the high speed rotary gear member 14 formed in a small size to have a predetermined gear ratio, for example, a gear ratio of 1/2 or 1/3 or less, with respect to the diameter of the rotary gear member 10 is designed to allow the high speed rotary gear member 14 engaging with the rotary gear member 10 to rotate at high speed upon rotation of the rotary gear member 10.

Furthermore, the small generators 11 is provided at one side thereof with a fan member 15 to cool the small generators 11 which generates heat while rotating at high speed.

In one embodiment, the axle shaft 4 is provided with a plurality of rotary gear members 10, for example, two pairs of rotary gear members 10 such that each pair of rotary gear members 10 is provided to a left or right side of the wheel 2B to engage with the corresponding high speed rotary gear members 14 of the small generators 11 which are also placed at the left or right side of the wheel 2B.

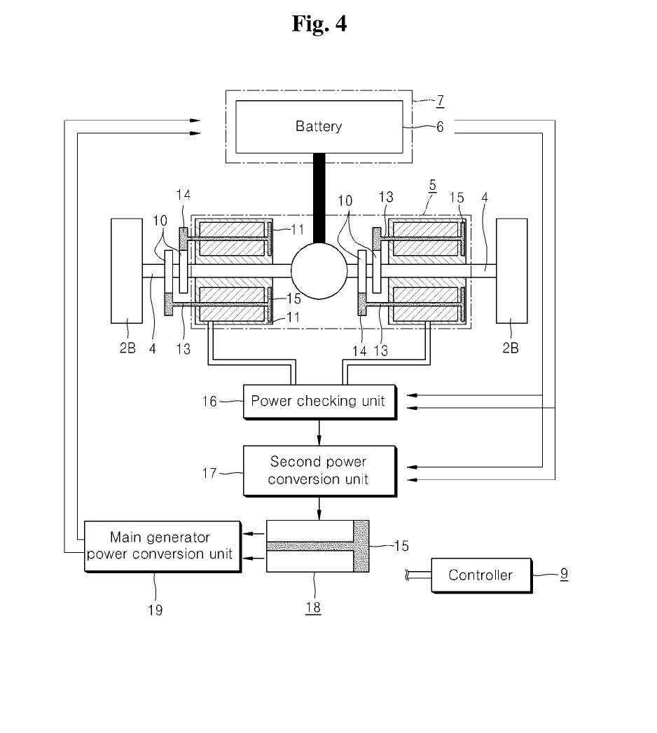

In the embodiment shown in FIG. 4, the power supply apparatus may further include:

a power checking unit 16 which is connected to an output end of each of the small generators 11 of the small power generation unit 5, checks AC power generated by each of the small generators 11 to output a detection signal indicating an abnormal state of each of the small generators 11 to the controller 9, and collects the allocated AC power normally generated by each of the small generators 11 to output resupply AC power;

a second power conversion unit 17 which converts the resupply AC power output from the power checking unit 16 into DC power to output the DC power;

a main generator 18 connected between an output terminal of the second power conversion unit 17 and the charging unit 7 and actuated by the resupply DC power output from the second power conversion unit 17 to generate charging power for the battery 6; and

a main generator power conversion unit 19 which converts the AC power generated by the main generator 18 into DC power and supplies the converted DC power to the charging unit 7.

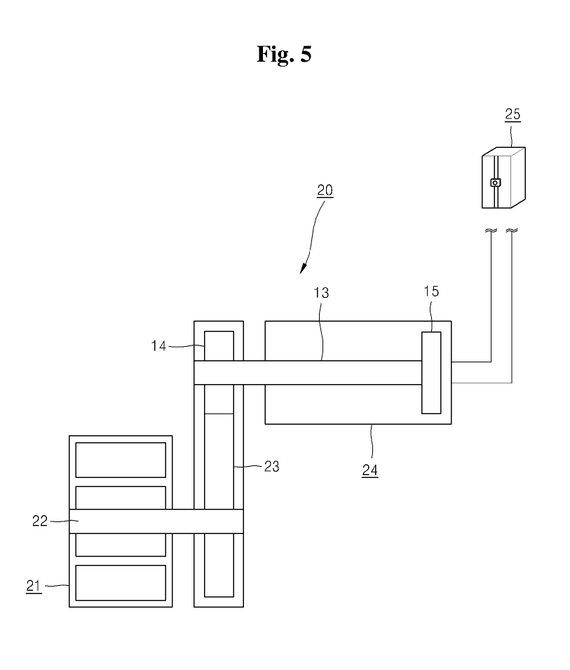

In a further embodiment, the power supply apparatus may be realized as an assistant power supply apparatus 20 to be disposed within the trunk of the electric car 3, or to be separated from the electric car 3 in use. Referring to FIG. 5, the assistant power supply apparatus 20 may further include:

a power checking unit 16 which is connected to an output end of each of the small generators 11 of the small power generation unit 5, checks AC power generated by each of the small generators 11 to output a detection signal indicating an abnormal state of each of the small generators 11 to the controller 9, and collects allocated AC power normally generated by each of the small generators 11 to output resupply AC power;

a rotor 21 connected to an output terminal of the power checking unit 16 to be rotated by the resupply power output through the power checking unit 16 and including a plurality of electromagnetic coils received therein;

a rotary gear member 23 coupled to a rotary shaft 22 of the rotor 21 to be rotated therewith;

a high speed rotary gear member 14 engaging with the rotary gear member 23 to rotate therewith and being formed in a small size to have a predetermined gear ratio, for example, a gear ratio of 1/2 or 1/3 or less, with respect to a diameter of the rotary gear member 23;

an assistant generator 24 connecting the high speed rotary gear member 14 to a rotor shaft 13 thereof and generating power according to rotation of the high speed rotary gear member 14 to charge the battery 6 of the charging unit 7 with the generated power; and

an assistant fan member 15 provided to the rotor shaft 13 of the assistant generator 24 to cool heat from the assistant generator 24.

In use of the assistant power supply apparatus 20 for domestic purposes, a starter battery 6 having temporary capacity is connected to the rotor 21 and the output terminal of the assistant generator 24 is connected to a distributing board 25 for domestic use.

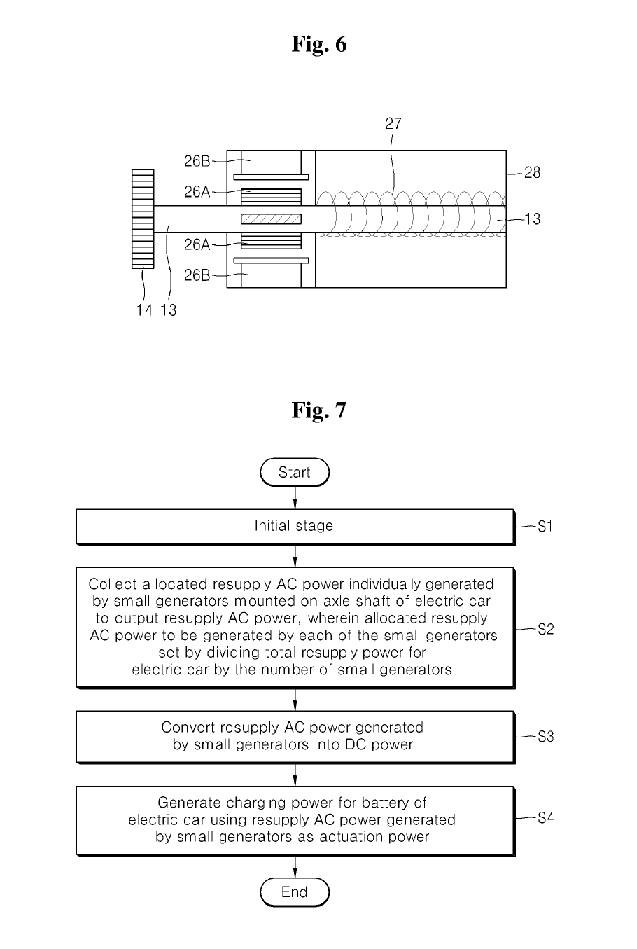

Each of the small generators 11, the main generator 18 and the assistant generator 24 has a common structure of a generator, and thus includes a rotor 13 rotated by external power; rotating sections 26A, 26B that rotate the rotor 13, a stator coil 27 wound around the rotor 13, and a case 28 receiving these components, as shown in FIG. 6. (see Korean Patent No. 1087704 of the applicant of the present invention.)

Next, a method of controlling the power supply apparatus according to the embodiments of the present invention will be described.

Referring to FIG. 7, the method of controlling the power supply apparatus includes:

a resupply power generating operation (S2) of collecting allocated resupply AC power individually generated by small generators mounted on an axle shaft of the electric car to output resupply AC power, wherein the allocated resupply AC power to be generated by each of the small generators is set in an initial stage (S1) by dividing total resupply power for the electric car by the number of small generators;

a DC power conversion operation (S3) of converting the resupply AC power generated by the small generators into DC power; and

a final power producing operation (S4) of generating charging power for a battery of the electric car using the resupply AC power generated by the small generators as actuation power.

The resupply power generating operation (S2) includes a direct battery charging operation of collecting the allocated AC power generated by the small generators mounted on the axle shaft of the electric car to convert the collected AC power into DC power, and producing charging power for the battery of the electric car from the DC power.

In addition, the resupply power generating operation (S2) may further include an abnormal state determining operation of determining, by a controller of the electric car, an abnormal state of each of the small generators generating the individually allocated power with reference to preset allocated power of each of the small generators.

Meanwhile, when constructing the power supply apparatus according to the present invention, a plurality of small generators 11 is mounted on the circular rotary gear members 10 concentrically provided to the axle shaft 4 of the electric car 3 to generate resupply power.

For example, a single small generator 11 or a pair of small generators 11 may be provided to either side of the axle shaft 4 of the wheels 2B of the electric car 3, to which the main drive motors 1 are not provided, by coupling the high speed rotary gear member 14 of each of the small generators 11 to the corresponding rotary gear member 10.

That is, the power supply apparatus includes a pair of small generators 11 or two pairs of small generators 11 disposed at right and left sides of the axle shaft 4 of the wheels 2B, and each of the rotary gear members 10 is engaged with the corresponding high speed rotary gear member 14 of each of the small generators 11 to be rotated together therewith.

Here, in each of the small generators 11, the high speed rotary gear member 14 is formed in a small size on the rotor shaft 13 protruding a predetermined length from the body of the small separator to have a predetermined gear ratio, for example, a gear ratio of 1/2 or 1/3 or less, with respect to the diameter of the rotary gear member 10 configured to rotate in connection with the axle shaft 4.

In addition, the configuration of the high speed rotary gear member 14 formed in a small size to have a predetermined gear ratio, for example, a gear ratio of 1/2 or 1/3 or less, with respect to the diameter of the rotary gear member 10 is designed to allow the high speed rotary gear member 14 engaging with the rotary gear member 10 to rotate at high speed upon rotation of the rotary gear member 10.

In operation of the power supply apparatus 8, the controller 9 of the electric car 3 divides total resupply power for the electric car 3 by the number of small generators mounted on the axle shaft 4 of the electric car 3 to preset allocated power to be generated by each of the small generators 11, and collects the allocated AC power generated by the individual small generators 11 to output resupply power.

At this time, in the structure wherein power generated by the small generators 11 is directly applied to the battery 6 of the charging unit 7, the first power conversion unit 12 converts AC power generated by the small generators 11 into DC power and transfers the converted DC power to the charging unit 7 while checking an abnormal state of the power generated by each of the small generators 11 and outputting information regarding abnormality of the power to the controller 9.

Then, the controller 9 compares the power generated by each of the small generators 11 with reference power allocated to each of the small generators 11, and allows the power generated by the small generators 11 to be used as resupply power or charging power if it is determined that the generated power reaches the reference power. On the contrary, when the generated power does not reach the reference power, the controller 9 determines that the corresponding small generator 11 has malfunctioned, and informs the result through a display (not shown) in order to take a suitable measure.

On the other hand, in the structure wherein power generated by the small generators 11 is used as resupply power, the power checking unit 16 checks AC power generated by each of the small generators 11 and outputs a detection signal indicating an abnormal state of each of the small generators 11 to the controller 9, while collecting the AC power normally generated by the individual small generators 11 to output resupply AC power to the power conversion unit 17. Then, the second power conversion unit 17 converts the AC resupply power output from the power checking unit 16 into DC resupply power to output the DC resupply power to the main generator 18.

Then, the main generator 18 is operated by the DC resupply power output from the second power conversion unit 17 to produce charging power for the battery 6 and outputs the charging power to the main generator power conversion unit 19. The main generator second power conversion unit 19 converts AC power generated by the main generator 18 into DC power to charge the battery 6 of the charging unit 7 with the DC power.

As a result, the power charged in the battery 6 may be used as power for activating the electric car 3.

Here, the power supply apparatus according to the present invention has a technical feature in that the high speed rotary gear member 14 of each of the small generators 11 is formed in a small size to have a predetermined gear ratio, for example, a gear ratio of 1/2 or 1/3 or less, with respect to the diameter of the rotary gear member 10 mounted on the axle shaft 4.

In other words, when the high speed rotary gear member 14 engages with and rotates together with the rotary gear member 10, the high speed rotary gear member 14 rotates at a very high speed and generates power, for example, with high efficiency of a theoretical value (100%) or more, since the high speed rotary gear members 14 has a diameter of ½ or ⅓ or less the diameter of the rotary gear member 10.

For example, assuming that four small generators 11 are mounted on the axle shaft 4, each of the small generators 11 is theoretically allocated to generate 25% of resupply power (100%). In the apparatus according to the present invention, however, since the high speed rotary gear member 14 of each of the small generators 11 is formed to have a small diameter of, for example, ½ or ⅓ or less the diameter of the rotary gear member 10 and can rotate at high speed, each of the small generators 11 generates a power of 25 W or more, and actual resupply power obtained by collecting the allocated power of the small generators reaches an efficiency of about 100%, that is, about 100 W.

Then, the resupply power (100%) of approximately 100 W is applied to the main generator 18, which in turn is actuated by a resupply power (100%) of approximately 100 W and generates a power of 125 W, that is, 125% of the resupply power to charge the battery 6 of the charging unit 7 with the generated power.

As a result, the main drive motor 1 is activated by power of the battery 6 charged by the procedure as described above, thereby driving the electric car.

Here, since each of the small generators 11, main generator 18 and secondary generator 24 rotates at a higher speed than a theoretical speed, a large amount of heat is generated therein but cooled by the fan members 15 mounted on the rotor shafts 13 of the generators 11, so that the generators 11 can be operated in a normal state.

During the charging operation as described above, in the assistant power supply apparatus 20 according to the other embodiment of the present invention, the rotor 21 is rotated by the resupply power of 100% (for example, 100 W) supplied from the small generators 11 via the power checking unit 16. Then, when the rotor 21 is rotated, the rotary gear member 23 mounted on the rotary shaft 22 of the rotor 21 is also rotated. At this time, the high speed rotary gear member 14 mounted on the assistant generator 24 of the assistant power supply apparatus 20 engages with the rotary gear member 23 and rotates therewith.

Here, in the assistant power supply apparatus, the high speed rotary gear member 14 of the assistant generator 24 is formed in a small size to have a predetermined gear ratio, for example, a gear ratio of 1/2 or 1/3 or less, with respect to the diameter of the rotary gear member 23 mounted on the rotary shaft 22. Thus, when the high speed rotary gear member 14 engages with and rotates together with the rotary gear member 23, the high speed rotary gear member 14 rotates at a very high speed and generates power, for example, with high efficiency of a theoretical value (125%) or more. Then, the resupply power (125%) (for example 125 W) is used as charging power for the battery 6.

At this time, the assistant fan member 15 provided to the rotor shaft 13 of the assistant generator 24 cools heat generated from the assistant generator 24 while rotating together with the rotor shaft 13.

Furthermore, when the assistant power supply apparatus 20 is used for domestic purposes, the assistant power supply apparatus 20 is separated from the electric car 3 and installed at a certain place in home. Then, a starter battery 6 having temporary capacity is connected to the rotor 21. For example, a starter battery 6 of 100 W corresponding to a theoretical value 100% (or a set of five 20 W batteries connected in series) is connected to the rotor 21 to rotate the rotor 21 with a power of 100 W corresponding to a theoretical value 100%. When the rotor 21 is rotated, the rotary gear member 23 mounted on the rotary shaft 22 of the rotor 21 is also rotated. At this time, the high speed rotary gear member 14 mounted on the assistant generator 24 of the assistant power supply apparatus 20 engages with the rotary gear member 23 and rotates therewith.

Here, since the high speed rotary gear member 14 of the assistant generator 24 is formed in a small size to have a predetermined gear ratio, for example, a gear ratio of 1/2 or 1/3 or less, with respect to the diameter of the rotary gear member 23 mounted on the rotary shaft 22, the high speed rotary gear member 14 rotates at a very high speed and generates power, for example, with high efficiency of a theoretical value (125%) or more, when the high speed rotary gear member 14 engages with and rotates together with the rotary gear member 23. Then, among the produced power of 125% (for example, 125 W), a power of 25%, that is, a power of 25 W, is used as power for domestic purposes through a distributing board 25 for domestic use, and the remaining power of 100%, that is, a power of 100 W, is used as power for driving the rotor 21 after removing the starter battery 6 from the rotor 21.

As such, according to the present invention, a plurality of small generators is mounted on the axle shaft of the electric car such that power generated by the small generators is resupplied to a main generator to generate desired power of high efficiency to charge a battery of the electric car, whereby the electric car can eliminate a need for a separate power source for actuation of the electric car, thereby maximizing fuel efficiency.

In addition, each of rotary gears provided to the plurality of small generators has a much smaller diameter than the diameter of a rotary gear mounted on the axle shaft and thus can be rotated at high speed. Accordingly, the small generators have improved power generation capability, thereby improving efficiency in production of electric energy.

Although some exemplary embodiments have been described herein, it should be understood by those skilled in the art that these embodiments are given by way of illustration only, and that various modifications, variations and alterations can be made without departing from the spirit and scope of the present invention. Therefore, the scope of the present invention should be limited only by the accompanying claims and equivalents thereof.

What is claimed is:

1. A power supply apparatus of an electric car comprising:
a small power generation unit including a plurality of small generators mounted on an axle shaft of wheels of the electric car, to which a main drive motor is not provided, each small generators generating allocated resupply power preset in association with rotation of the axle shaft;
a charging unit including a battery mounted in a trunk of the electric car, the charging unit charging the battery with the power generated by the small power generation unit and supplying power for operation of electric and electronic circuits of the electric car and power for the main drive motor; and
a controller having a function of treating an abnormal state of the small generators and controlling overall operation of the power supply apparatus.

2. The power supply apparatus according to claim 1, wherein the axle shaft is provided with a plurality of concentric circle-shaped rotary gear members rotated in association with rotation of the axle shaft.

3. The power supply apparatus according to claim 1, wherein the small power generation unit comprises a pair of small generators each placed at either side of the axle shaft of the wheels of the electric car.

4. The power supply apparatus according to claim 3, wherein each of the small generators is provided with a first power conversion unit which converts AC power generated by each of the small generators into DC power and outputs the DC power to the charging unit while checking a state of the power generated by each of the small generator to output a signal indicating abnormality of the power to the controller.

5. The power supply apparatus according to claim 1, wherein the small power generation unit comprises two pairs of small generators, each pair being placed at either side of the axle shaft of the wheels of the electric car.

6. The power supply apparatus according to claim 5, wherein each of the small generators comprises a high speed rotary gear member formed in a small size on a rotor shaft protruding a predetermined length from a body of the small separator to have a predetermined gear ratio with respect to a diameter of a rotary gear member configured to rotate in connection with the axle shaft.

7. The power supply apparatus according to claim 6, wherein the predetermined gear ratio is 1/2 or 1/3 or less.

8. The power supply apparatus according to claim 5, wherein each of the small generators is provided at one side thereof with a fan member cooling the small generator.

9. The power supply apparatus according to claim 6, wherein two pairs of rotary gear members are placed at right and left sides of the axle shaft and engage with the high speed rotary gear members of the two pairs of small generators placed at the right and left sides of the axle shaft of the wheels of the electric car to rotate together with the high speed rotary gear members.

10. The power supply apparatus according to claim 5, further comprising;
a power checking unit which is connected to an output end of each of the small generators and checks AC power generated by each of the small generators to output a detection signal indicating an abnormal state of each of the small generators to the controller, while collecting allocated AC power normally generated by the small generators to output resupply AC power;
a second power conversion unit which converts the resupply AC power output from the power checking unit into DC power to output the DC power;
a main generator connected between an output terminal of the second power conversion unit and the charging unit and actuated by the resupply DC power output from the second power conversion unit to generate charging power for the battery; and
a main generator power conversion unit which converts the AC power generated by the main generator into DC power and supplies the converted DC power to the charging unit.

11. The power supply apparatus according to claim 5, further comprising:
an assistant power supply apparatus connected to an output end of each of the small generators, the assistant power supply apparatus comprising:
a power checking unit which is connected to the output end of each of the small generators and checks AC power generated by each of the small generators to output a detection signal indicating an abnormal state of each of the small generators to the controller, while collecting allocated AC power normally generated by the small generators to output resupply AC power;
a rotor connected to an output terminal of the power checking unit to be rotated by the resupply power output through the power checking unit and including a plurality of electromagnetic coils received therein;
a rotary gear member coupled to a rotary shaft of the rotor to be rotated therewith;
a high speed rotary gear member engaging with the rotary gear member to rotate therewith and being formed in a small size to have a predetermined gear ratio with respect to a diameter of the rotary gear member;
an assistant generator connecting the high speed rotary gear member to a rotor shaft thereof and generating power according to rotation of the high speed rotary gear member to charge the battery of the charging unit with the generated power; and
an assistant fan member provided to the rotor shaft of the assistant generator to cool the assistant generator.

12. The power supply apparatus according to claim 11, wherein, when the secondary power supply apparatus is used for domestic purposes, a starter battery having temporary capacity is connected to the rotor and an output terminal of the assistant generator is connected to a distributing board for domestic use.

13. A method of controlling a power supply apparatus of an electric car, comprising:
collecting allocated resupply AC power individually generated by small generators mounted on an axle shaft of the electric car to output resupply AC power, the allocated resupply AC power to be generated by each of the small generators being set by dividing total resupply power for the electric car by the number of small generators;
converting the resupply AC power generated by the small generators into DC power; and
generating charging power for a battery of the electric car using the resupply AC power generated by the small generators as actuation power.

14. The method according to claim 13, wherein the collecting allocated resupply AC power further comprises collecting the allocated AC power generated by the small generators mounted to convert the collected AC power into DC power, and producing charging power for the battery of the electric car from the DC power.

15. The method according to claim 13, wherein the collecting allocated resupply AC power further comprises determining, by a controller of the electric car, an abnormal state of each of the small generators generating the individually allocated power with reference to preset allocated power of each of the small generators.
